(19) United States
(12) Patent Application Publication
(10) Pub. No.: US 2005/0194409 A1
(43) Pub. Date: Sep. 8, 2005

(54) Packed, flowable fibrous or highly viscous dental materials

(75) Inventors: Christian Bressler, Frankfurt (DE); Novica Savic, Ranstadt (DE); Karl-Heinz Renz, Jettingen (DE)

Correspondence Address: Kurt G. Briscoe;Norris, McLaughlin & Marcus P.A., 875 Third Avenue - 18th Floor, New York, NY, 10022, US

(73) Assignee: Heraeus Kulzer GmbH, Hanau (DE)

(21) Appl. No.: 11/056,999

(22) Filed: Feb. 11, 2005

(30) Foreign Application Priority Data
Feb. 12, 2004 (DE) 10 2004 007 121.7

(51) Int. Cl. B67B 7/00; G01F 11/00; B67D 5/42

(52) U.S. Cl. 222/389

(57) ABSTRACT

Bicameral pressurized containers are suitable for the packing and dispensing of flowable highly viscous or flowable fibrous dental materials.

The invention concerns the packing and dispensing of flowable fibrous or flowable highly viscous dental materials and a bicameral pressurized pack containing such materials.

So far materials of this kind are dispensed via a complex compressed air and cartridge system that is also used in adhesive application, for example, using the system Delomat of the company Delo.

What proves to be disadvantageous is the dependence on the compressed air network and power supply system or on other mechanic resources that are required for the application.

U.S. Pat. No. 3,240,403 describes a bicameral pressurized dispensing system for, e.g., dental elastic impression material. Highly viscous or fibrous materials are not described in that patent application.

U.S. Pat. No. 6,425,503 describes a specially designed valve that is suitable for fibrous materials and is supposed to prevent any clogging caused by deposits.

WO 98/32675 concerns a bicameral pressurized multi-dose dispenser containing a wound gel with a viscosity of 150 to 800 Pa·s. Because of the internal pressure the container is self-sealing, can be operated using only one hand and the gel can be used to treat body parts that are difficult to access.

What is aimed for is the device-independent application of a flowable, fibrous or highly viscous single-component dental material whose viscosity lies preferably in the range of 10³-10⁷ mPas. The viscosity is determined in accordance with ISO 3219.

The fibers contained are, for example, short fibers with a length of 0.2-3.0 mm and a diameter of 15-500 μm.

The task is resolved by the use of a bicameral pressurized pack. Such pressurized packs are known in prior art. The advantage of the bicameral system as opposed to conventional aerosol cans is the separation of propellant and paste so that complications like formation of bubbles are avoided. Bicameral systems that come into question are the ones in which one chamber is filled with compressed gas that exerts pressure on the second chamber and even those bicameral systems in which the pressure is not built-up by gas but instead mechanically, for example, by compressed rubber or foamed plastic materials. Even systems in which the pressure is generated from the outside on a flexible plastic bottle or a plastic bag (e.g., the Exxel system, further described below, using expanded rubber) are considered. Furthermore bicameral systems can be used in which the pressure room and the product room can be separated by a mobile piston and the product room is compressed, for example, by gas pressure from the pressure room.

For example, a container with a valve comprising a stiff material is suitable for use as a bicameral pressurized pack. The container is equipped with a device that uses the contraction force of an expanded rubber tube and/or an expanded product container for dispensing the composition stored in it. Such a dispenser is described in the EP 069 699. Even the containers marketed by the 3D Dispenser Distributions GmbH under the name of FlexPack™ use the reset force of an expanded rubber for dispensing the composition. Containers that prove to be suitable here are those that contain a folded, essentially gas-impermeable flexible inner bag comprising a chemically inert plastic (e.g., PET) that is surrounded by an elastic thick-walled rubber tube. Dispensers of this type are described in the U.S. Pat. No. 5,927,551, U.S. Pat. No. 4,964,540 and EP 069 738 and are distributed by the company Exxel Container under the name of Atmos Dispensing System.

Such containers were not used so far for fibrous materials and highly viscous dental materials because of the fear that the materials could clog the dispensing valve.

Surprisingly, it was found that fibrous and highly viscous dental materials can be handled without any problems in such bicameral pressurized containers. Also repeated dispensing processes in longer periods of time do not impair the function of the opening and closing of the valve. Thus fibrous materials can be conveyed without any problems via conventional valves.

Bicameral aerosol cans with inner bags are suitable for use as dispensers. They comprise a flexible container for the flowable material. The container is enclosed by a gas pressure chamber and is connected to a dispensing valve. If the dispensing valve is opened then the flexible container is pressed together by the gas pressure and the material is dispensed. Systems of such type can be loaded either via an opening on the base of the can or by lifting the valve—as is the case in the so-called ‘under cup system’. The invention thus concerns a bicameral pressurized pack with a pressure chamber containing a compressed gas and a material chamber with a dispensing valve that is connected to it wherein the material chamber contains a flowable, highly viscous or a flowable fibrous dental material. Material chambers with flexible bags are preferred.

Pressurized gas containers in which the aerosol can comprises aluminum or tinplate are particularly suitable. The distortable inner bag usually comprises plastic, composite material (e.g., plastic laminate or aluminum laminate) or aluminum foil, partly painted aluminum cases. These inner bags collapse under pressurization.

The valves that can be considered for use as dispensing valves include: plate valves, male aerosol valves, female aerosol valves. The so-called ‘PU valve’ is preferably used. These are special valves that are characterized by a high output quantity. They are hence especially suitable for polyurethane or silicone products. They are also used in the field of cosmetics and in the household or food industry. The combination of valve and bag can also be advantageous, e.g., the ‘bag-on-valve’ system of the company Lindal. The bag-on-valve system comprises an aerosol valve with a bag that is welded on to it. It is particularly suitable for gel-based products.

The particular advantage of the use of the pressurized pack in accordance with the invention is that a device-independent application is possible in which the user can directly use the material without additional devices (ready-for-use packing). Moreover, during the use of this packing no ambient air can enter into the product room. Thus there is no risk of recontamination.

The use of the pressurized pack in accordance with the invention applies particularly to the packing of light-curing single-component prosthesis base material. Furthermore packings of dental products with similar viscosity range such as, e.g., products for the individualization of teeth, prostheses, crowns, bridges, as well as every type of bonding agent and product in gel form is possible.

### BRIEF DESCRIPTION OF THE DRAWING

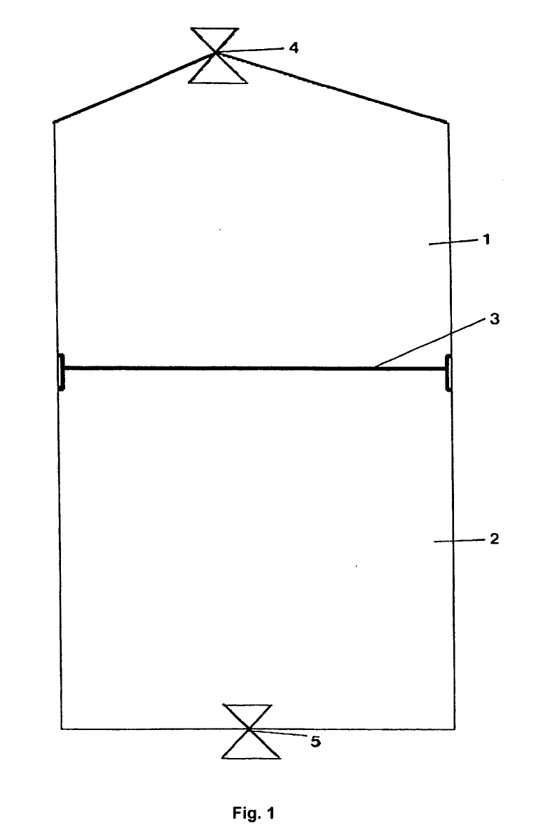

A design form of the invention is elucidated on the basis of FIG. 1.

In the bicameral pressurized pack illustrated there, pressure chamber 2 and product chamber 1 are separated by a mobile piston 3. The product is dispensed after opening the dispensing valve 4. Inversely, the product flow is stopped after closing the dispensing valve 4. The gas valve 5 is used for bringing in the pressure gas.

The material contained is, e.g., a light-curing single-component prosthesis plastic, e.g. of the following composition: cross-linked organic matrix of dimethacrylate and multifunctional meth-/acrylates, (trade name ‘Versyo® direct’, Heraeus Kulzer). Components include, among others: trimethylolpropane trimethacrylate (CAS: 3290-92-4), aliphatic urethane acrylate; ethoxylated (2) bispheno A dimethacrylate (CAS: 24448-20-2) and 2,2-dimethoxy-1,2-diphenylethane-1-one (CAS: 24650-42-8).

1. Bicameral pressurized pack comprising (a) a pressure chamber containing a compressed gas and (b) a product chamber with a dispensing valve operably linked to the product chamber, wherein the product chamber contains a flowable, highly viscous fibrous dental material.

2. Bicameral pressurized pack in accordance with claim 1, wherein the product chamber is a flexible bag.

3. Bicameral pressurized pack in accordance with claim 1, wherein the flowable, highly viscous fibrous dental material comprises fibers that are 0.2-3.0 mm long.

4. Bicameral pressurized pack in accordance with claim 1, wherein the flowable, highly viscous fibrous dental material comprises fibers that have a diameter of 15-500 μm.

5. Bicameral pressurized pack in accordance with claim 1, wherein the flowable, highly viscous fibrous dental material has a viscosity in the range of 10³ to 10⁷ mPa s.

6. A method for packing and dispensing a flowable, highly viscous fibrous dental material, said method comprising:
(a) providing a bicameral pressurized pack in accordance with claim 1; and
(b) operating said dispensing valve to dispense said flowable, highly viscous fibrous dental material.

7. Method in accordance with claim 6, wherein the flowable, highly viscous fibrous dental material comprises fibers that are 0.2-3.0 mm long.

8. Method in accordance with claim 6, wherein the flowable, highly viscous fibrous dental material comprises fibers that have a diameter of 15-500 μm.

9. Method in accordance with claim 6, wherein the flowable, highly viscous fibrous dental material has a viscosity in the range of 10³ to 10⁷ mPa s.
